(19) United States
(12) Patent Application Publication
(10) Pub. No.: US 2019/0016243 A1
(43) Pub. Date: Jan. 17, 2019

(54) SELF-STORING SEAT COVERS FOR MODULAR SEATS AND METHODS OF USING THE SAME

(71) Applicant: Anne Pancol, Anderson, IN (US)

(72) Inventor: Anne Pancol, Anderson, IN (US)

(21) Appl. No.: 15/649,381

(22) Filed: Jul. 13, 2017

(51) Int. Cl. B60N 2/60; B60N 2/24

(52) U.S. Cl. CPC B60N 2/60; B60N 2/24; B60N 2/6063

(57) ABSTRACT

Seat cover systems include a cover and a pouch. The cover extends around the seat. A reversible pouch opens through the cover to store the cover or other articles in the pouch. The cover can be any shape to fit around the seat, including a rectangular prism-shape. The pouch can be fit between the cover and seat for storing articles through the opening in the cover in use and may have a zipper at the opening that seals the pouch. A latch or hook can be attached to the pouch or zipper to secure the pouch to a golf bag, such as when it is storing the cover. The cover can be waterproof, insulated, padded, soft, and/or multi-layered to prevent permeation from the seat to the rider. The pouch can also hold a separate back cover that covers back cushions of the cart.

### BACKGROUND

FIG. 1 is a perspective view of a related art golf cart 1 having a modular seat 10 with cushion and separate seat back 11. As shown in FIG. 1, modular seat 10 is typically shaped to accommodate two riders, in a standard rectangular design that is modular, or separate from, the rest of cart 1. For example, modular seat 10 may be approximately 4 feet long and two feet wide to accommodate two riders, and seat 10 may have 2-6 inches of cushion depth; a standard, modular size of 47×29×6 inches is common for seat 10. Variation in shape and size is common, with cut-outs and curves to edges of seat 10. A matching back cushion 11 is conventionally separate from seat 10, potentially as a single back or multiple separate back as shown in FIG. 1 with two back cushions 11.

As shown in FIG. 1, modular seat 10 conventionally is removable or rotatable to open cart 1 for access to a battery, engine, transmission, and/or any other internal cart system. In this way, seat 10 may be separate from the remainder of cart 1, with surfaces accessible without disassembly. Seat 10 conventionally has a waterproof or impermeable cover, such as a vinyl, nylon, neoprene, or other flexible plastic to prevent water ingress into cushion material or into internals of cart 1. Because carts and other vehicles conventionally having such modular seats are often rented or used by multiple parties in variable outdoor conditions, seat 10 may be wiped down and/or cleaned between uses or as water or other liquids gather on seat 10.

### SUMMARY

Example embodiments seat covers and related systems including a cover and a pouch. The cover can be multi-layered with an outer surface on which to sit and an inner surface that fits to the seat. The cover can be three-dimensional so as to surround the seat and all upper and side surfaces of the same. The cover can be drawn under the seat, such as with an elastic band running a complete edge of the cover, a drawstring hemmed into the bottom edge of the cover, a fitted size of the bottom of the cover, etc. The cover attaches to a reversible pouch opening through the cover so that the cover can be stored into the pouch, which is big enough to hold the same. The cover can be at least 3 ft×2 ft×4 inches, such as 47 inches×29 inches×6 inches so as to fully cover a top and sides and at least part of the bottom of a rectangular prism-shaped seat cover or similar. The pouch can be reversed in use to fit between the cover and seat for storage through the opening in the cover and may have a zipper or other sealing structure at the opening that seals the pouch when installed or storing the cover. A latch or hook can be fitted on the pouch or zipper to attach the pouch to another object, such as when it is storing the cover. The cover can be waterproof, insulated, padded, soft, and otherwise comfortable for seating without allowing liquid or soil to permeate from the seat covered by the cover. The pouch may be large enough to also hold a separate back cover that covers back cushions of the cart, similarly to the cover.

In use, the cover can be fitted over the external surfaces of the seat and around the seat in multiple dimensions to no portion of the seat is exposed except for a non-contacted bottom. A drawstring or elastic band can hold the cover in the fitted position by drawing under the seat. A back cover can be similarly installed on one or more back cushions. The pouch can be situated between the seat and cover and opened to insert articles into the pouch for storage. If the pouch includes a zipper, the zipper may be closed to seal the pouch and present a smooth seating surface. The cover may also be removed from the seat and the pouch reversed through the opening. In this way, the cover can then fit into the reversed pouch for storage, and the zipper may seal the cover into the pouch. Any back cover may also be removed and fit into the pouch with the cover, storing all elements together.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the terms which they depict.

FIG. 1 is a perspective view of a related art golf cart with modular seat.

FIG. 2 is a perspective view of an example embodiment modular seat cover system as installed.

FIG. 3 is an illustration of an example embodiment modular seat system in a storage configuration.

### DETAILED DESCRIPTION

Because this is a patent document, general, broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

It will be understood that, although the ordinal terms “first,” “second,” etc. may be used herein to describe various elements, these elements should not be limited to any order by these terms. These terms are used only to distinguish one element from another; where there are “second” or higher ordinals, there merely must be that many number of elements, without necessarily any difference or other relationship. For example, a first element could be termed a second element, and, similarly, a second element could be termed a first element, without departing from the scope of example embodiments or methods. As used herein, the term “and/or” includes all combinations of one or more of the associated listed items. The use of “etc.” is defined as “et cetera” and indicates the inclusion of all other elements belonging to the same group of the preceding items, in any “and/or” combination(s).

It will be understood that when an element is referred to as being “connected,” “coupled,” “mated,” “attached,” “fixed,” etc. to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, a term such as “communicatively connected” includes all variations of information exchange and routing between two electronic devices, including intermediary devices, networks, etc., connected wirelessly or not.

As used herein, the singular forms “a,” “an,” and the are intended to include both the singular and plural forms, unless the language explicitly indicates otherwise. Indefinite articles like “a” and “an” introduce or refer to any modified term, both previously-introduced and not, while definite articles like “the” refer to the same previously-introduced term. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof.

The structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, so as to provide looping or other series of operations aside from single operations described below. It should be presumed that any embodiment or method having features and functionality described below, in any workable combination, falls within the scope of example embodiments.

The inventor has recognized that conventional modular seats are often easily soiled and wetted between shared and outdoor uses without the possibility of replacement or adequate cleaning, such that later contact with the same results in transmission of unwanted dirt, liquid, and other communicable materials. Moreover, conventional modular seats for outdoors typically use materials with an uncomfortable “skin feel” and/or temperature when exposed to the sun, such as when an impermeable, non-breathable plastic or other material contacts the legs or exposed skin of a rider for long amounts of time, as is common during outdoor activities, resulting in sticky or sweaty contact areas that potentially compound the transmission problem previously discussed. Even further, conventional modular seats lack storage for personal items such as sunglasses, keys, wallet, balls, tees, gloves, etc., which typically must be placed in pockets or other open portions of a cart, exposing them to the outdoor elements. To overcome these newly-recognized problems as well as others, the inventor has developed example embodiments and methods described below to address these and other problems recognized by the inventor with unique solutions enabled by example embodiments.

The present invention is self-storing and removable covers for modular seats and methods of using the same. In contrast to the present invention, the few example embodiments and example methods discussed below illustrate just a subset of the variety of different configurations that can be used as and/or in connection with the present invention.

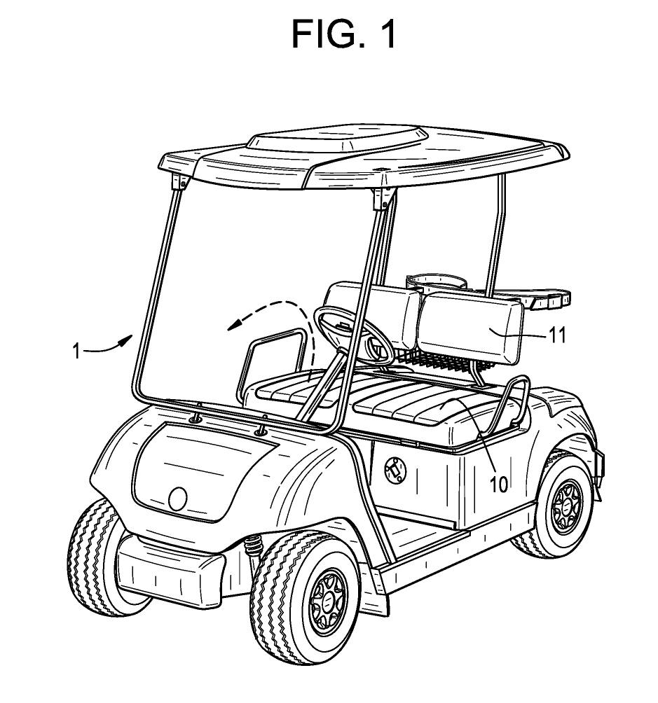

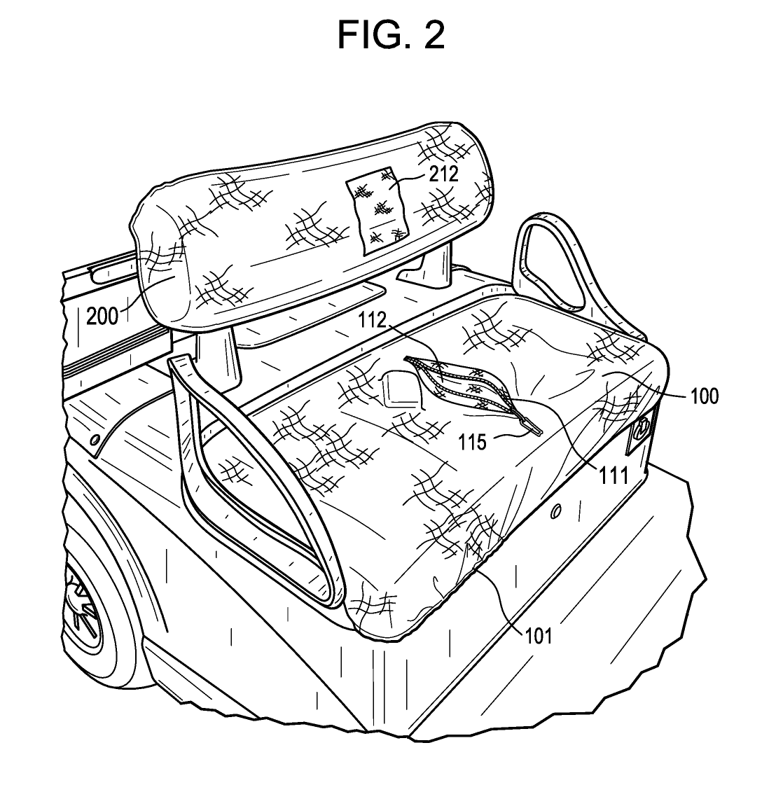

FIG. 2 is an illustration of an example embodiment seat cover 100 as installed on a golf cart seat, like seat 10 of FIG. 1. As shown in FIG. 2, example embodiment cover 100 has a shape and configuration to cover the golf cart seat. For example, cover 100 may be generally rectangular of approximately 47 inches long and 29 inches wide. Cover 100 may also have depth of several inches to fully envelope exposed surfaces of the seat and even around a lower, unexposed surface of the seat. Because the modular seat may have a variable shape or size among different carts or other vehicles, cover may include an elastic or draw-able lower edge 101. For example, an elastic band or drawstring may be sewn into, made into, and/or hemmed into lower edge 101. Example embodiment cover 100 may also include seating hems and/or elastic in a depth direction along corners to better seat and cling around the seat. In this way cover 100 may removably secure around a variety of seats with an adjustable but secure fit.

Example embodiment cover may be made of a soft, comfortable material that blocks moisture and/or dirt from underlying seat coming into contact with a person sitting on cover 100. For example, cover 100 may include a jersey or terry cloth upper layer with an impermeable nylon, tweed, polyurethane laminate, paper, vinyl-coated polyester, and/or stretched PTFE lower layer for both comfort and moisture-blocking. Or, for example, cover 100 may include only a single layer, like a single layer of nylon, polyester, cotton, waterproof canvas, and blends thereof. Insulating and cushioning materials may also be used between layers or otherwise in cover 100 to prevent extreme heat-cold transfer upon contact and improve comfort. Although several different materials are discussed as examples, it is understood that any fabric(s) that blocks contact with underlying seat can be used in cover 100 in any combination or layer number. Moreover, any design, logo, pattern, or other aesthetic treatment may be placed on surface of cover 100 to be displayed when installed on a seat.

Example embodiment cover 100 includes a reversible storage pouch 112 that permits both storage of articles and cover 100 itself. For example, pouch 112 may be a 10-inch square flexible pouch connected, by sewing, stitching, bonding, zippering, snaps, velcro, through an integral fabric layer, etc., to an underside of cover 100. Of course, pouch 112 may be other sizes and shapes, as long as cover 100 can be stored in the same. Pouch 112 opens to a reverse or topside of cover 100 through a slit or other opening in cover 100. In this way, articles like money, phones, glasses, etc. can be inserted into pouch 112 under cover 100 as installed on a seat. Pouch 112 can also be inverted and pulled out to the topside of cover 100 so that cover 100 can then be placed into pouch 112 while still attached to the same. Pouch 112 may be waterproof or otherwise impermeable to further safeguard articles or cover 100 stared therein. Although pouch 112 is shown in a middle of cover 100 for easy access by both seated passengers on sides of pouch 112, it is understood that other locations and orientations of pouch 112 are useable in example embodiments.

Example embodiment cover 100 may include a reversible or double zipper 111 lining any slit or opening so as to removably seal pouch 112. In this way, cover 100 may present a seamless, closed surface when installed on the seat with zipper closed, while securing items inside. Similarly, pouch 112 may store cover 100 in a sealed way. Zipper 111 may be double or reversible on the edge of any pouch opening to allow opening and closing when inverted or regular. Other seals, including elastic bands, buttons, toggles, Velcro, may reversibly seal pouch 112 as well. A clip 115 or other attachment may be connected to zipper 111 and/or edge of pouch 112 to allow each removable attachment to a belt loop, keychain, golf bag, etc.

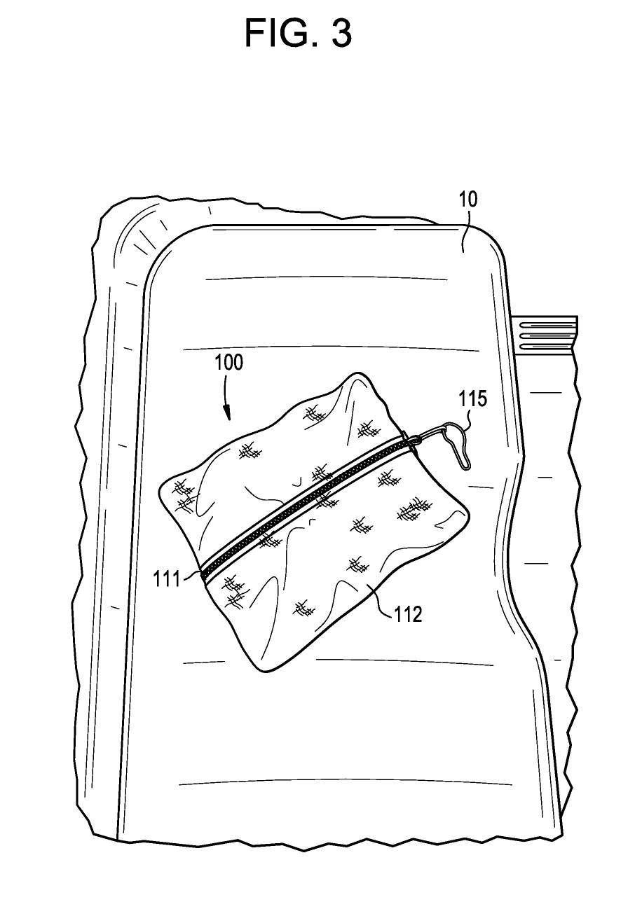

FIG. 3 is an illustration of example embodiment cover 100 as stored in pouch 112 inverted to store the same. As seen in FIG. 3, pouch 112 may be inverted through zipper 111 lining the same, and cover is then inserted into the new interior of pouch 112. If pouch 112 and an opening through cover 100 are near a middle of cover 100 as shown in FIG. 2, then cover 100 may automatically evenly fit into pouch 112; if pouch 112 is located near an edge of cover 100, some adjustment and repositioning of cover 100 into pouch 112 may achieve a desired fit. Zipper 111 may then be drawn up to seal cover 100 in pouch 112. Hook 115 may then easily secure all of pouch 112 and cover 100 to another structure for storage and/or travel.

FIG. 2 illustrates a back cover 212 that is useable with example embodiment cover 100. For example, back cover 212 may include a similar elastic lining and material as cover 100 to seat to removably secure around seat backs of the golf cart, like backs 11 of FIG. 1. Multiple back covers 212 may be used for individual sear backs and/or a single back cover 212 may extend around multiple backs. An additional storage net or pouch 212 may be present on seat back cover 200 as well as on cover 100 in any number, providing additional storage. Back cover 200 may also fit in pouch 112 with articles and/or cover 100, allowing for complete storage of all elements in pouch 112 as shown in FIG. 3. Together with cover 100, back cover 212 may permit substantial or complete coverage of a separate seat, like a golf cart seat 10 and back cushion 11 (FIG. 1), about all its surfaces, preventing or limiting uncomfortable, wetting, and/or soiling contact with the direct surface of seat 10 and back cushion 11.

Example embodiments and methods thus being described, it will be appreciated by one skilled in the art that example embodiments may be varied and substituted through routine experimentation while still falling within the scope of the following claims. For example, although covers are shown in use on a golf cart, other types of modular seats like those on school busses, ski lifts, boats, etc. can be used simply through proper dimensioning of example embodiments—and fall within the scope of the claims. Such variations are not to be regarded as departure from the scope of these claims.

1. A cover system for use on a seat, the system comprising:
a cover having an outer surface and an inner surface, wherein the cover is shaped to extend in three different dimensions so as to fit the inner surface to multiple external surfaces of the seat, wherein the cover includes an edge configured to draw the cover around the seat, wherein the cover extends over three feet in a longest dimension at least 4 inches in a shortest dimension, and at least 2 feet in a remaining dimension of the three different dimensions so as to fit the inner surface to multiple external surfaces of the seat having a rectangular parallelepiped shape configured to seat two people;
a pouch extending from the cover and opening at an opening in the cover, wherein the pouch,
is sized to hold the cover in its entirety,
is configured to reverse to extend from the outer surface,
includes a zipper to seal the cover inside the pouch when the pouch is reversed and seal articles in the pouch between the seat and the cover when the pouch is not reversed, and
is configured to fit between one of the external surfaces of the seat when not reversed and be accessible for storage of the articles through the opening when the cover is installed on the seat, wherein the cover is configured to fit inside the pouch as reversed, and wherein the cover and pouch are waterproof; and
a back cover separate from the cover and sized to fit in the pouch with the cover.

2-3. (canceled)

4. The system of claim 1, wherein the zipper further includes a releasable hook configured to secure the pouch to another object.

5. The system of claim 1, wherein the outer surface is terry cloth.

6. The system of claim 1, wherein the edge includes an elastic band.

7-11. (canceled)

12. A method of covering and using a golf cart seat shaped to seat two people sitting beside each other on the golf cart, the seat attached to the golf cart to permit movement of the seat relative to the golf cart, the method comprising:
fitting a cover over all external surfaces of the seat, wherein the cover includes,
an outer surface and an inner surface that fits to the external surfaces of the seat during the fitting, and wherein the cover includes an edge configured to draw the cover around the seat, and
a pouch extending from the cover and opening at an opening in the cover, wherein the pouch is sized to hold the cover in its entirety;
positioning the pouch between the inner surface and at least one of the external surfaces of the seat;
removing the cover from the seat;
reversing the pouch to extend from the outer surface; and
inserting the cover fully into the pouch.

13. (canceled)

14. The method of claim 12, further comprising:
inserting an article into the pouch for storage; and
sealing the pouch with a zipper on the pouch.

15. (canceled)

16. The method of claim 12, wherein the edge includes an elastic band that is fitted under the seat during the fitting.

17. The method of claim 12, wherein the cover extends over three feet in a longest dimension at least 4 inches in a shortest dimension, and at least 2 feet in a remaining dimension so as to fit over the seat having a rectangular parallelepiped shape.

18. The method of claim 17, wherein the cover and pouch are waterproof, and wherein the pouch includes a zipper to seal the cover inside the pouch when the pouch is reversed and seal articles in the pouch between the seat and the cover when the pouch is not reversed.

19. The method of claim 18, further comprising:
fitting a back cover separate from the cover on a back seat of the golf cart.

20. The method of claim 19, further comprising:
removing the back cover and storing the cover and the back cover in the pouch.
